(19) United States
(12) Patent Application Publication
(10) Pub. No.: US 2023/0042138 A1
(43) Pub. Date: Feb. 9, 2023

(54) METHOD AND APPARATUS FOR SIDELINK POSITIONING IN WIRELESS COMMUNICATION SYSTEM

(71) Applicant: Samsung Electronics Co., Ltd., Gyeonggi-do (KR)

(72) Inventors: Cheolkyu SHIN, Gyeonggi-do (KR); Hyunseok RYU, Gyeonggi-do (KR); Youngbum KIM, Gyeonggi-do (KR); Jeongho YEO, Gyeonggi-do (KR)

(21) Appl. No.: 17/869,300

(22) Filed: Jul. 20, 2022

(30) Foreign Application Priority Data
Jul. 20, 2021 (KR) 10-2021-0095152

(51) Int. Cl. H04W 64/00; H04L 5/00

(52) U.S. Cl. CPC H04W 64/00; H04L 5/0048

(57) ABSTRACT

Disclosed is a method, performed by a terminal, that includes transmitting positioning capability information of the terminal to at least one of a base station or another terminal, receiving positioning configuration information from at least one of the base station, the other terminal or a location server connected with at least one of the base station or the other terminal, receiving a sidelink-positioning reference signal (S-PRS) based on the positioning configuration information, and transmitting positioning information based on the S-PRS.

### CROSS-REFERENCE TO RELATED APPLICATION(S)

This application is based on and claims priority under 35 U.S.C. § 119 to Korean Patent Application No. 10-2021-0095152, filed in the Korean Intellectual Property Office on Jul. 20, 2021, the entire disclosure of which is incorporated herein by reference.

### BACKGROUND

### 1. Field

The disclosure relates to a wireless mobile communication system, and more particularly, to a method and apparatus for performing positioning through a sidelink.

### 2. Description of the Related Art

A review of the development of mobile communication from generation to generation shows that the development has mostly been directed to technologies for services targeting humans, such as voice-based services, multimedia services, and data services. It is expected that connected devices that are exponentially increasing after commercialization of 5th generation (5G) communication systems will be connected to communication networks. Examples of things connected to networks may include vehicles, robots, drones, home appliances, displays, smart sensors connected to various infrastructures, construction machines, and factory equipment. Mobile devices may be expected to evolve into various form factors, such as augmented reality glasses, virtual reality headsets, and hologram devices. In order to provide various services by connecting hundreds of billions of devices and things in a 6th generation (6G) era, there have been ongoing efforts to develop improved 6G communication systems. For these reasons, 6G communication systems are referred to as beyond-5G systems.

6G communication systems, which are expected to be implemented approximately by year 2030, will have a maximum transmission rate of tern (i.e., 1,000 giga)-level bits per second and a radio latency of 100 microseconds (μsec). In other words, the transmission rate of the 6G communication systems is 50 times faster than that of the 5G communication systems, and wireless latency is reduced to one tenth.

In order to accomplish such a high data transmission rate and an ultra-low latency, it has been considered to implement 6G communication systems in a terahertz band (e.g., 95 GHz to 3 THz bands). It is expected that, due to server path loss and atmospheric absorption in the terahertz bands that exceed losses in mmWave bands introduced in 5G, a technology capable of securing the signal transmission distance, i.e., coverage area, will become more crucial. It is necessary to develop, as major techniques for securing coverage, multi-antenna transmission techniques, such as new waveform, beamforming, massive multiple-input and multiple-output (MIMO), full dimensional MIMO (FD-MIMO), array antenna, or large-scale antenna, which exhibit better coverage characteristics than radio frequency (RF) devices and orthogonal frequency division multiplexing (OFDM). In addition, there has been an ongoing discussion on new techniques for improving the coverage of terahertz-band signals, such as metamaterial-based lenses and antennas, high-dimensional spatial multiplexing technology using an orbital angular momentum (OAM), and reconfigurable intelligent surface (RIS).

Moreover, to improve frequency efficiencies and system networks, several technologies have been developed for 6G communication systems, e.g.: a full duplex technology for enabling an uplink (UL) and a downlink (DL) to use the same frequency resource at the same time; a network technology for utilizing satellites, integrated high-altitude platform stations (HAPS); a network structure innovation technology for supporting mobile base stations and enabling network operation optimization and automation; a dynamic spectrum sharing technology though collision avoidance based on spectrum use prediction, an artificial intelligence (AI)-based communication technology for implementing system optimization by using AI from the design phase and internalizing end-to-end AI support functions; and a next-generation distributed computing technology for implementing a service having a complexity that exceeds the limit of terminal computing ability by using super-high-performance communication and computing resources (mobile edge computing (MEC), clouds, and the like). In addition, attempts have been made to further enhance connectivity between devices, further optimize networks, promote software implementation of network entities, and increase the openness of wireless communication through design of new protocols to be used in 6G communication systems, development of mechanisms for implementation of hardware-based security environments and secure use of data, and development of technologies for privacy maintenance methods.

Such research and development of 6G communication systems may enable the next hyper-connected experience in new dimensions through the hyper-connectivity of 6G communication systems that covers both connections between things and connections between humans and things. That is, services such as truly immersive extended reality (XR), high-fidelity mobile holograms, and digital replicas could be provided through 6G communication systems. In addition, with enhanced security and reliability, services such as remote surgery, industrial automation, and emergency response will be provided through 6G communication systems. Thus, these services will be applied to various fields including industrial, medical, automobile, and home appliance fields.

### SUMMARY

The disclosure relates to a wireless mobile communication system, and more particularly, to a method and apparatus for performing positioning through a sidelink. The disclosure, which has been made to address at least the above-mentioned problems and/or disadvantages and to provide at least the advantages described below, relates to and provides a method for measuring a location of a terminal, a method of configuring and transmitting a signal for measuring the location, a method of measuring the location by using the signal, and terminal operations for performing the methods.

According to an embodiment, a method performed by a terminal is provided, the method including transmitting positioning capability information of the terminal to at least one of a base station or another terminal, receiving positioning configuration information from at least one of the base station, the other terminal or a location server connected with at least one of the base station or the other terminal, receiving a sidelink-positioning reference signal (S-PRS) based on the positioning configuration information, and transmitting positioning information based on the S-PRS.

According to another embodiment, a terminal is provided that includes a transceiver and at least one processor coupled with the transceiver, with the transceiver being configured to transmit positioning capability information of the terminal to at least one of a base station or another terminal, receive positioning configuration information from at least one of the base station, the other terminal or a location server connected with at least one of the base station or the other terminal, receive a sidelink-positioning reference signal (S-PRS) based on the positioning configuration information, and transmit positioning information based on the S-PRS.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a system according to an embodiment;

FIG. 2 illustrates communication methods performed through sidelinks, according to an embodiment;

FIG. 3 describes a resource pool defined by a set (group) of resources on time and frequency used for transmission and reception of a sidelink, according to an embodiment;

FIG. 4 describes examples of calculating a location of a terminal through a sidelink by applying a sidelink positioning protocol (SSP), according to an embodiment;

FIG. 5 describes examples of calculating a location of a terminal through a sidelink, according to an embodiment;

FIG. 6 describes examples of calculating a location of a terminal through a sidelink, according to an embodiment;

FIG. 7 describes examples of calculating a location of a terminal through a sidelink, according to an embodiment;

FIG. 8 illustrates an internal structure of a terminal according to an embodiment; and

FIG. 9 illustrates an internal structure of a base station according to an embodiment.

### DETAILED DESCRIPTION

Hereinafter, embodiments of the disclosure are described in detail with reference to the accompanying drawings.

In the description of embodiments, technical features that are well known to the technical field to which the disclosure belongs but are not directly associated with the disclosure are not described to avoid obscuring the gist of the disclosure with unnecessary description.

For the same reason, in the accompanying drawings, some elements are exaggerated, omitted, or schematically shown. In addition, sizes of elements do not fully reflect actual sizes thereof. Like reference numbers are used to refer to like elements through at the drawings.

Throughout the disclosure, the expression at least one of a, b or c indicates only a, only b, only c, both a and b. both a and c. both b and c, all of a, b, and c. or variations thereof.

Throughout the disclosure, a layer may also be referred to as an entity.

Advantages and features of the disclosure and a method for achieving them will be apparent with reference to embodiments of the disclosure described below together with the attached drawings. The disclosure may, however, be embodied in many different forms and should not be construed as being limited to the embodiments set forth herein, rather, these embodiments are provided such that the disclosure will be thorough and complete, and will fully convey the concept of the disclosure to those of ordinary skill in the art, and the disclosure will be defined only by the concept of the claims. Like reference numerals denote like elements throughout the disclosure.

Here, it could be understood that each block in processing flowchart drawings and combinations of flowchart drawings may be performed by computer program instructions. These computer program instructions may be loaded in a processor of a general-purpose computer, a particular-purpose computer, or other programmable data processing equipment, and thus, the instructions performed by a processor of a computer or other programmable data processing equipment may generate a means configured to perform functions described in flowchart block(s). These computer program instructions may also be stored in a computer-usable or computer-readable memory capable of orienting a computer or other programmable data processing equipment to implement a function in a particular mode, and thus, the instructions stored in the computer-usable or computer-readable memory may also produce a production item involving an instruction means configured to perform a function described in flowchart block(s). These computer program instructions may also be loaded in a computer or other programmable data processing equipment, and thus, a computer-executable process may also be generated by performing a series of operation steps on the computer or the other programmable data processing equipment so that the instructions executed in the computer or the other programmable data processing equipment provide steps for executing functions described in flowchart block(s).

In addition, each block may indicate a portion of a module, a segment, or a code including one or more executable instructions for executing particular logical function(s). Also, in several substitutional embodiments, functions described in blocks may also be out of a sequence. For example, two consecutively shown blocks may be substantially performed at the same time in fact, or the blocks may be sometimes performed in a reverse order according to a corresponding function.

The term unit used in the embodiments of the disclosure denotes a component including software or hardware, such as a field programmable gate array (FPGA) or an application-specific integrated circuit (ASIC), and the unit performs certain roles. However, the unit does not always have a meaning limited to software or hardware. The unit may be configured either to be stored in an addressable storage medium or to execute one or more processors. Therefore, for example, the unit includes components, such as software components, object-oriented software components, class components, and task components, processes, functions, attributes, procedures, subroutines, segments of program code, drivers, firmware, microcode, circuits, data, a database, data structures, tables, arrays, and variables. A function provided inside components and units may be combined into a smaller number of components and units or be further divided into additional components and units. In addition, components and units may be implemented to reproduce one or more central processing units (CPUs) inside a device or a security multimedia card. Also, in an embodiment, the unit may include one or more processors.

Embodiments of the disclosure will be described mainly based on a radio access network (RAN), i.e., new RAN, and a core network, i.e., a packet core (a 5th Generation (5G) system, a 5G core network, or a next generation (NG) core), in the 5G mobile communication standard specified by the mobile communication standardization organization, 3rd Generation Partnership Project (3GPP), but it will be understood by those skilled in the art that the gist of the disclosure is applicable to other communication systems having similar technical backgrounds without significant modifications departing from the scope of the disclosure.

In a 5G system, a network data collection and analysis function (NWDAF), which is a network function that provides a function of analyzing data collected from a 5G network and providing an analysis result, may be defined to support network automation. The NWDAF may collect/store/analyze information from 5G networks and provide the results to unspecific network functions (NFs), and the analysis results may be used independently by each NF.

Hereinafter, for convenience of description, some terms and names defined in standards of 3GPP (e.g., standards of 5G, NR, long-term evolution (LTE), or similar systems) may be used. However, the disclosure is not limited by these terms and names, and may be applied in the same way to systems that conform other standards.

In addition, as used herein, terms for identifying access nodes, terms referring to network entities, terms referring to messages, terms referring to interfaces between network entities, terms referring to a variety of identification information, and the like are exemplified for convenience of description. Accordingly, the disclosure is not limited to the terms used herein, which may be replaced with other terms referring to objects having equivalent technical meanings.

To meet the demand for wireless data traffic having increased since commercialization of 4th Generation (4G) communication systems, efforts have been made to improve 5G communication systems (new radio (NR)). In order to achieve a high data transmission rate, the 5G communication systems have been designed to enable resources in an ultra-high frequency (mmWave) band (e.g., a 28-GHz frequency band). In order to mitigate path loss of radio waves and increase a propagation distance of radio waves in an ultra-high frequency band, beamforming, MIMO, FD-MIMO, array antenna, analog beamforming, and large-scale antenna technologies have been discussed in 5G communication systems. Further, unlike LTE, 5G communication systems support various subcarrier spacings such as 30 kHz, 60 kHz, and 120 kHz, including 15 kHz, a physical control channel uses polar coding, and a physical data channel uses low-density parity check (LDPC). In addition, cyclic-prefix OFDM as well as discrete Fourier transform-spread OFDM (DFT-S-OFDM) is used as a waveform for UL transmission. In LTE, hybrid automatic repeat request (HARQ) retransmission in transport blocks (TBs) is supported, whereas 5G may additionally support code block group (CBG)-based HARQ retransmission in which a plurality of CBs (code blocks) are bundled.

In addition, in order to improve a network of a 5G communication system, technologies such as evolved small cell, advanced small cell, cloud RAN, ultra-dense network, device-to-device (D2D) communication, wireless backhaul, vehicular communication network (e.g., vehicle-to-everything (V2X) network), cooperative communication, coordinated multi-points (COMP), and received-interference cancelation, have been developed.

The Internet has evolved from a human-centered connection network, through which humans generate and consume information, to an Internet-of-things (IoT) network that exchanges and processes information between distributed elements such as objects. Internet of everything (IoE) technology in which a big data processing technology via a connection with a cloud server or the like is combined with the IoT technology has also emerged. In order to implement IoT, technical factors, such as sensing technology, wired/wireless communication, network infrastructure, service-interface technology, and security technology are required, and research on technologies, such as a sensor network, machine-to-machine (M2M) communication, machine-type communication (MTC), and the like for connection between objects has recently been conducted. In an IoT environment, via collection and analysis of data generated from connected objects, an intelligent internet technology (IT) service to create new value for peoples' lives may be provided, IoT may be applied to various fields, such as smart homes, smart buildings, smart cities, smart cars or connected cars, smart grids, health care, smart home appliances, or high-tech medical services, via the convergence and combination of existing information technology and various industries.

Accordingly, various attempts are being made to apply 5G communication systems to IoT networks. For example, technologies such as a sensor network, M2M communication, and MTC are implemented by beamforming, MIMO, or array antenna schemes. The application of cloud RAN as the big data processing technology described above may be an example of convergence of 5G communication technology and IoT technology. As such, in a communication system, a plurality of services may be provided to a user, and to provide the plurality of services to the user, a method of providing each of the plurality of services in the same time period according to the characteristics and an apparatus using the method is required. Various services provided in a 5G communication system are being studied, and one of them is a service that satisfies requirements of low latency and high reliability. In addition, the demand for mobile services is exploding, and location-based services (LBSs), which are mainly driven by two main requirements, i.e., emergency services and commercial applications, are rapidly growing. In particular, in communication using a sidelink, an NR sidelink system supports unicast communication, groupcast (or multicast) communication, and broadcast communication between terminals. In addition, unlike LTE sidelinks that aim to transmit and receive basic safety information required for driving a vehicle on a road, NR sidelinks aim to provide more advanced services such as platooning, advanced driving, extended sensor, and remote driving.

In particular, in NR sidelinks, positioning may be performed through a sidelink between terminals. In other words, a method of measuring a location of a terminal by using a positioning signal transmitted through a sidelink may be considered. A related-art method of measuring a location of a terminal by using a positioning signal transmitted through a DL and a UL between a terminal and a base station is feasible only when the terminal is within the coverage area of the base station. However, by introducing sidelink positioning, the location of a terminal may be measured even when the terminal is out of a coverage area of a base station. The disclosure provides a method of transmitting and receiving relevant information for measuring a location of a terminal through a sidelink, a method of configuring and transmitting a signal for measuring the location, and a method of measuring the location by using the signal.

Set forth below are embodiments that provide a method and apparatus for measuring a location of a terminal in a sidelink.

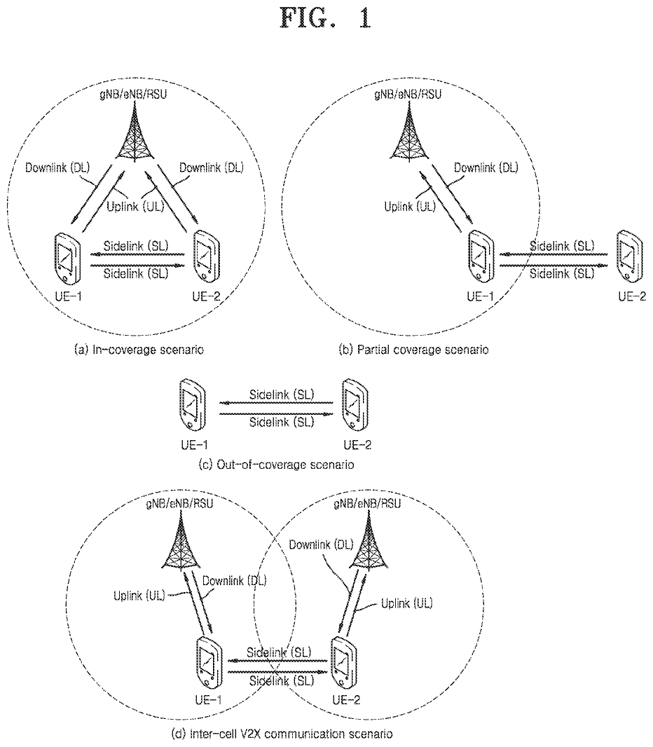

FIG. 1 illustrates a system according to an embodiment.

Part (a) of FIG. 1 illustrates all user equipments (UEs), i.e., UE-1 and UE-2, performing communication via sidelinks being located within the coverage area of a base station (i.e., an in-coverage (IC) scenario). Accordingly, all of the UEs are able to receive data and control information from the base station through a DL or transmit data and control information to a base station through a UL. Herein, the data and control information may be for sidelink communication. The data and control information may also be for general cellular communication. In addition, the UEs may transmit/receive data and control information for corresponding communication through a sidelink (SL).

Part (b) of FIG. 1 illustrates an example in which, among the UEs, UE-1 is located within the coverage area of the base station and UE-2 is located outside the coverage area of the base station. That is, part (b) of FIG. 1 illustrates a partial coverage (PC) scenario in which only some terminals (e.g., only UE-2) are located outside the coverage area of the base station. UE-1, which is the UE located within the coverage area of the base station, is able to receive data and control information from the base station through a DL or transmit data and control information to the base station through a UL. UE-2, which is the UE that is located outside the coverage area of the base station, is unable to receive data and control information from the base station through a DL, and is unable to transmit data and control information to the base station through a UL. UE-2 is able to transmit/receive data and control information for corresponding communication to/from the UE UE-1 through an SL.

Part (c) of FIG. 1 illustrates a scenario in which all of the UEs are located outside the coverage area of the base station (i.e., an out-of-coverage (OOC) scenario). Accordingly, both UE-1 and UE-2 are unable to receive data and control information from the base station through a DL, and also is unable to transmit data and control information to the base station through a UL. The UEs UE-1 and UE-2 are able to transmit/receive data and control information through an SL.

Part (d) of FIG. 1 illustrates a scenario in which sidelink communication is performed between UE-1 and UE-2, which are each located in a different respective cell. That is, part (d) of FIG. 1 illustrates an example in which UE-1 and UE-2 are connected to different respective base stations (i.e., a radio resource control (RRC)-connected state), or UE-1 and UE-2 are camping on the respective base stations (i.e., an RRC-disconnected state or an RRC idle state). In this case, UE-1 may be a transmitting terminal and UE-2 may be a receiving terminal in an SL. Alternatively, UE-1 may be a receiving terminal and UE-2 may be a transmitting terminal in the SL. UE-1 may receive a system information block (SIB) from a base station to which UE-1 is connected (or on which UE-1 camps), and UE-2 may receive an SIB from another base station to which UE-2 is connected (or on which UE-2 camps). In this case, an existing SIB may be used as the SIB, or an SIB separately defined for sidelink communication may be used as the SIB. In addition, information of the SIB received by UE-1 and information of the SIB received by UE-2 may be different from each other. Accordingly, in order to perform sidelink communication between the UEs UE-1 and UE-2 located in different cells, a method of interpreting SIB information transmitted from different cells may be additionally required by unifying the information or by signaling the information.

Although FIG. 1 illustrates an SL system including two UEs, i.e., UE-1 and UE-2, for convenience of description, the disclosure is not limited thereto and communication may be performed between more than two UEs. In addition, an interface (a UL and a DL) between a base station and UEs may be referred to as a Uu interface, and an SL communication between UEs may be referred to as a PC5 interface. Therefore, in the disclosure, these terms may be interchangeably used, Meanwhile, terminal or UE may refer to a general UE and a UE supporting V2X. That is, a terminal or UE may be a handset (e.g., a smart phone) of a pedestrian. Alternatively, terminal or UE may include a vehicle that supports vehicle-to-vehicle (V2V) communication, a vehicle that supports vehicle-to-pedestrian (V2P) communication, a vehicle that supports vehicle-to-network (V2N) communication, or a vehicle that supports vehicle-to-infrastructure (V2I) communication. In addition, terminal or UE may include a road side unit (RSU) equipped with terminal functions, an RSU equipped with base station functions, or an RSU equipped with some of base station functions and some of terminal functions. In addition, a base station may support both V2X communication and general cellular communication, or may support only V2X communication. In this case, the base station may be a 5G base station (i.e., a next generation node B (NB)), a 4G base station (i.e., an evolved NB (eNB)), or an RSU, Therefore, a base station may also be referred to as an RSU.

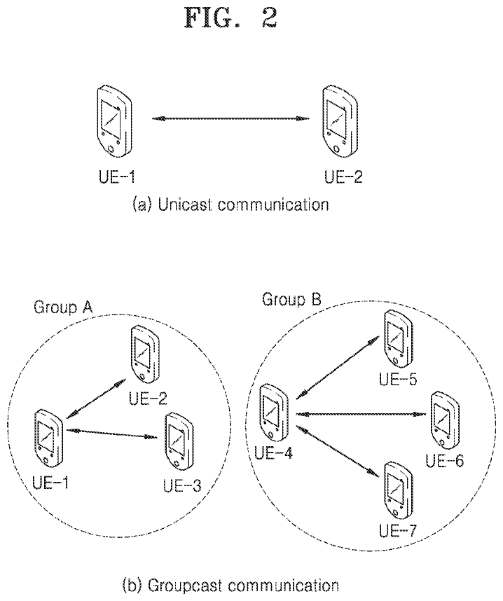

FIG. 2 illustrates communication methods performed through as, according to an embodiment.

Part (a) of FIG. 2 illustrates a UE-1 (e.g., a TX terminal) and a UE-2 (e.g., an RX terminal) that may perform one-to-one communication, which may be referred to as unicast communication. In an SL, capability information and configuration information may be exchanged between UE-1 and UE-2 through PC5-RRC defined in a unicast link between the UEs. Also, the configuration information may be exchanged through a medium access control (MAC) control element (CE) defined in the unicast link between the UEs.

Part (b) of FIG. 2 illustrates a TX terminal and RX terminals may perform one-to-many communication, which may be referred to as groupcast or multicast communication. In part (b) of FIG. 2, UE-1, UE-2, and UE-3 constitute one group to perform groupcast communication, and UE-4, UE-5, UE-6, and UE-7 constitute another group to perform groupcast communication. Each UE performs groupcast communication only within the group to which the UE belongs, and communication between different groups may be performed through unicast, groupcast, or broadcast communication. Part (b) of FIG. 2 illustrates two groups, i.e., Group A and Group B, but the disclosure is not limited thereto.

Meanwhile, UEs may perform broadcast communication in SLs. Broadcast communication refers to a case in which data and control information transmitted by a transmitting terminal through SLs are received by all other terminals. For example, assuming that, in part (b) of FIG. 2, the UE UE-1 is a transmitting terminal for broadcast, all other UEs, i.e., UE-2, UE-3, UE-4, UE-5, UE-6. and UE-7, receive data and control information transmitted by UE-1.

Unlike LTE V2X, NR V2X may support a case in which one vehicle terminal transmits data to only one node through unicast and a case in which one vehicle terminal transmits data to a plurality of nodes through groupcast. For example, such unicast and groupcast techniques may be useful for a service scenario, such as platooning being a technique that connects two or more vehicles via a network to drive them as a cluster. That is, a leader node of a group of nodes for platooning may perform unicast communication to control a particular node of the group, and may perform groupcast communication to simultaneously control a plurality of nodes of the group.

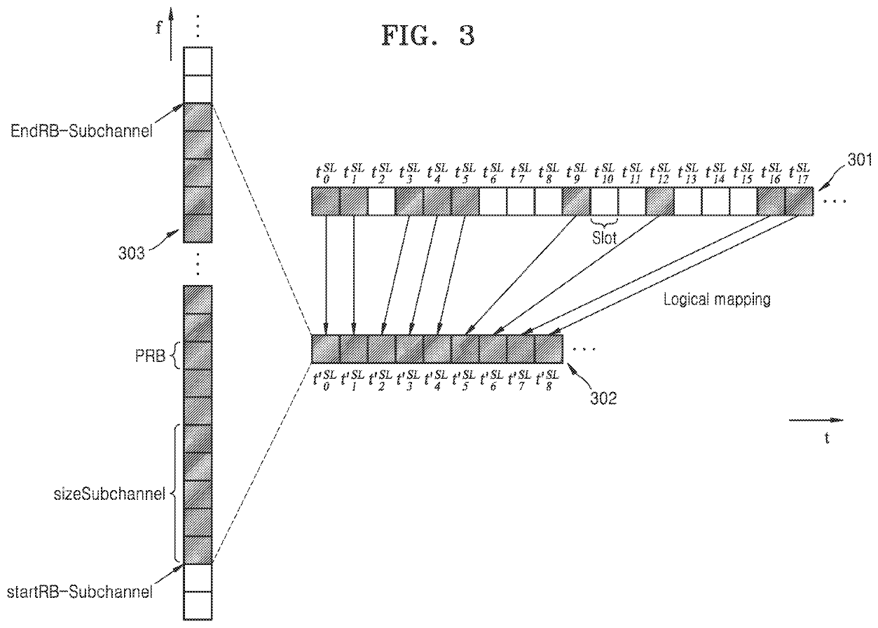

FIG. 3 describes a resource pool defined by a set (group) of resources on time and frequency used for transmission and reception of an SL, according to an embodiment. In the resource pool, the resource allocation unit (i.e., resource granularity) of the time axis may be slot, In addition, the resource allocation unit of the frequency axis may be sub-channel consisting of one or more physical resource blocks (PRBs). An example in which the resource pool is discontinuously allocated on the time axis is described, but a resource pool may be continuously allocated on the time axis. Although, an example in which the resource pool is continuously allocated on the frequency axis is described, a method of discontinuously allocating a resource pool on the frequency axis is not excluded from the present disclosure.

Referring to FIG. 3, item 301 illustrates a resource pool is discontinuously allocated on the time axis, with granularity of resource allocation on the time axis being a slot. SL slots may be defined within slots used for a UL. That is, the length of symbols used for an SL in one slot may be configured in SL bandwidth part (BWP) information. Therefore, among the slots used for the UL, slots in which the length of symbols configured as an SL is not guaranteed are unable to serve as SL slots. In addition, slots in which an SL synchronization signal block (S-SSB) is transmitted are excluded from the slots belonging to the resource pool. Item 301 of FIG. 3 illustrates a set of slots that may be used for an SL on the time axis except for such slots as t₀^{SL} t₁^{SL} t₂^{SL} . . . , with shaded portions representing SL slots belonging to the resource pool. The SL slots belonging to the resource pool may be (pre-)configured in resource pool information through a bitmap. Item 302 of FIG. 3 illustrates the set of the SL slots belonging to the resource pool on the time axis as a t′₀^{SL} t′₁^{SL} t′₂^{SL} . . . ). (Pre-)configuration may refer to configuration information, which is pre-configured and then stored in a terminal, or may refer to a case in which a terminal is configured by a base station in a cell-common manner. Here, cell-common may mean that terminals in a cell receive the same information configuration from a base station. In this case, the terminals may consider a method of receiving an SL-SIB from the base station and obtaining cell-common information. In addition, (pre-)configuration may refer to a case in which a terminal is configured in a UE-specific manner after an RRC connection with a base station is established. Here, UE-specific may be replaced with UE-dedicated, and may mean that each terminal receives configuration information with a particular value. In this case, the terminal may consider a method of receiving an RRC message from the base station and obtaining UE-specific information. In addition, a method of performing (pre-) configuration in resource pool information, and a method of performing (pre-) configuration not in resource pool information may be considered. In a case in which (pre-)configuration is performed in resource pool information, all terminals operating in a corresponding resource pool may operate according to common configuration information, except for the terminals configured in a UE-specific manner after an RRC connection with the base station is established. However, the method of performing (pre-)configuration not in resource pool information is basically to perform the (pre-) configuration independently of the resource pool configuration information. For example, one or more modes may be (pre-)configured in a resource pool (e.g., A, B, and C), and which one of the (pre-)configured modes to use in the resource pool (e.g., A, B, or C) may be indicated through information (pre-)configured independently of resource pool configuration information.

Referring to Item 303 of FIG. 3 illustrates a resource pool is continuously allocated on the frequency axis. Resource allocation in the frequency axis may be configured in SL BWP information, and may be performed in sub-channels. A sub-channel may be defined as a resource allocation unit on the frequency axis including one or more PRBs, That is, a sub-channel may be defined as an integer multiple of PRB, Referring to item 303 of FIG. 3, a sub-channel may be composed of 5 consecutive PRBs, and the size of a sub-channel, i.e., sizeSubchannel, may be the size of 5 consecutive PRBs. However, the configuration illustrated in FIG. 3 is only an example, and the size of a sub-channel may be set differently and one sub-channel is composed of consecutive PRBs in general, but a sub-channel is not necessarily composed of consecutive PRBs. Sub-channel may be a basic unit of resource allocation for a physical SL shared channel (PSSCH). In item 303 of FIG. 3, startRB-Subchannel may indicate the starting position of a sub-channel on the frequency axis in a resource pool. When resource allocation on the frequency axis is performed in units of sub-channels, resources on the frequency axis may be allocated according to the indices of resource blocks (RBs) (startRB-subchannel) at which sub-channels start, respectively, information about the number of PRBs in one sub-channel (sizeSubchannel), and configuration information about the total number of sub-channels (numSubchannel). In this case, information about startRB-Subchannel, sizeSubchannel, and numSubchannel may be (pre-)configured in frequency-axis resource pool information.

A method of allocating transmission resources in an SL is to receive SL transmission resources from a base station when a terminal is within the coverage area of the base station. Hereinafter, this method is referred to as Mode 1. In other words, Mode 1 may be a method, performed by a base station, of allocating resources used for SL transmission to RRC-connected terminals in a dedicated scheduling scheme. Mode 1 enables a base station to manage resources of an SL, and is effective in interference management and resource pool management. On the other hand, methods of allocating transmission resources in an SL include allocating transmission resources through direct sensing by a terminal in an SL. Allocating transmission resources through direct sensing by a terminal in an SL is referred to as Mode 2 or UE autonomous resource selection. Unlike Mode 1 in which a base station directly participates in resource allocation, in Mode 2, a transmitting terminal autonomously selects resources through a sensing and resource selection procedure defined based on a (pre-)configured resource pool, and transmits data through the selected resources. Next, when transmission resources are allocated through Mode1 or Mode2, the terminal may transmit/receive data and control information through an SL. Here, the control information may include SL control information (SCI) format 1-A as first-stage SCI transmitted through a physical SL control channel (PSCCH). In addition, the control information may include at least one of SCI format 2-A or SCI format 2-B, as a second-stage SCI transmitted through a PSSCH.

Hereinafter, a method is described of using a positioning reference signal (PRS) transmitted through a DL and a UL of a terminal and a base station, for positioning to measure a location of the terminal. The method uses a positioning signal transmitted through a DL and a UL of a terminal, and a base station is referred to as radio access technology (RAT)-dependent positioning. In addition, other positioning methods may be classified as RAT-independent positioning. In an LTE system, as a RAT-dependent positioning scheme, methods such as observed time difference of arrival (OTDOA), UL time difference of arrival (UTDOA), and enhanced cell identification (E-CID) may be used, In an NR system, methods such as DL time difference of arrival (DL-TDOA), DL angle-of-departure (DL-AOD), multi-round trip time (multi-RTT), NR E-CID, UL time difference of arrival (UL-TDOA), and UL angle-of-arrival (UL-AOA) may be used. On the other hand, RAT-independent positioning schemes may include assisted global navigation satellite systems (A-GNSS), a sensor, a wireless local area network (WLAN), and Bluetooth,

The disclosure focuses on RAT-dependent positioning methods supported through an SL. As described above, RAT-dependent positioning is available only when a terminal is within the coverage area of a base station. In addition, for RAT-dependent positioning, positioning protocols such as LTE Positioning Protocol (LPP), LTE Positioning Protocol Annex (LPPa), and NR Positioning Protocol Annex (NRPPa) may be used. LPP is a positioning protocol defined between a terminal and a location server (LS), and LPPa and NRPPa are protocols defined between a base station and an LS, Here, an LS manages location measurement, and may perform a location management function (LMF). Herein, the LS may be referred to as an LMF or other names. In both LTE and NR systems, LPP is supported, and the following roles for positioning may be performed through LPP. A terminal and an LS perform the following roles, and a base station may perform a role of enabling the terminal and the LS to exchange positioning information. In this case, the exchange of positioning information through LPP may be performed in a base station-transparent manner, with the base station not being involved in the exchange of positioning information between the terminal and the LS. LPP may include the following components.

* Positioning capability exchange

*Assistance data transmission

*Location information transmission

*Error handling

*Abort

In the positioning capability exchange, the terminal may exchange supportable positioning information with the L.S. For example, the supportable positioning information may indicate whether a positioning method supported by the terminal is UE-assisted, UE-based, or both. Here, UE-assisted positioning is a scheme in which the terminal transmits only a measured value for a positioning scheme to the LS based on a received positioning signal without directly measuring the absolute position of the terminal, and the absolute position of the terminal is calculated by the LS. Here, the absolute position may refer to two-dimensional (x,y) and three-dimensional (x,y,z) coordinate position information of the terminal based on longitude and latitude. On the other hand, UE-based positioning may be a scheme in which the terminal may directly measure the absolute position of the terminal, and for this, the terminal needs to receive a positioning signal, together with position information of the source of the positioning signal.

While LTE systems support only UE-assisted schemes, NR systems may support both UE-assisted and UE-based positioning. Next, the assistance data transmission may be a significantly important factor in positioning, to accurately measure the location of the terminal. That is, in the assistance data transmission, the LS may provide the terminal with configuration information about the positioning signal, information about candidate cells and transmission reception points (TRPS) to receive the positioning signal, and the like. When DL-TDOA is used, the information about the candidate cells and TRPs to receive the positioning signal may be information about reference cells, reference TRPs, neighbor cells, and neighbor TRPs. In addition, a plurality of candidates for neighbor cells and neighbor TRPs may be provided, together with information about a preferred cell and TRP to be selected by the terminal to measure the positioning signal. In order for the terminal to accurately measure the location, it is necessary to properly select information about candidate cells and TRPs to be used as a reference. For example, when a channel for a positioning signal received from a corresponding candidate cell and TRP is a line-of-sight (LOS) channel, i.e., a channel having fewer non-LOS (NLOS) channel components, the accuracy of positioning measurement may increase. Therefore, when the LS provides the terminal with information about candidate cells and TRPs, which are the reference for performing positioning by collecting various pieces of information, the terminal may perform more accurate positioning measurement.

Next, the location information transmission may be performed through LPP. The LS may request location information from the terminal, and the terminal may provide measured location information to the LS in response to the request. In UE-assisted positioning, the location information may be a measured value with respect to a positioning scheme based on a received positioning signal. On the other hand, in UE-based positioning, the location information may be two-dimensional (x,y) and three-dimensional (x,y,z) coordinate position values of the terminal. When the LS requests the location information from the terminal, the LS may include required accuracy, response time, and the like, in positioning quality-of-service (QoS) information. Upon the request including the positioning QoS information, the terminal needs to provide the LS with the measured location information to satisfy the corresponding accuracy and response time, and, when it is impossible to satisfy the QoS, the terminal may consider error handling and abort. However, this is only an example, and error handling and abort may be performed on positioning in other cases than those in which it is impossible to satisfy QoS.

A positioning protocol defined between the base station and the LS is referred to as LPPa in LTE systems, and the following functions may be performed between the base station and the LS.

*E-CID location information transmission

*OTDOA information transmission

*General error state reporting

*Assistance information transmission

A positioning protocol defined between the base station and the LS is referred to as NRPPa in NR systems, and includes the roles performed by LPPa, and the following functions may be additionally performed between the base station and the LS.

*Positioning information transmission

*Measurement information transmission

*TRP information transmission

Unlike in LTE systems_{;} in NR systems, positioning measurement may be performed by a base station through a positioning sounding reference signal (SRS) transmitted by a terminal. Therefore, the positioning information transmission is a function of exchanging, between the base station and the LS, information related to configuration and activation/deactivation of a positioning SRS. The measurement information transmission is a function of exchanging, between the base station and the LS, information related to multi-RTT, UL-TDOA, and UL-AOA, which are not supported in LTE systems. The TRP information transmission is a role of exchanging information related to performing of TRP-based positioning, because TRP-based positioning may be performed in NR systems whereas cell-based positioning is performed in LTE systems.

Entities performing positioning-related configuration and entities calculating positioning for measuring a location of a terminal in an SL may be classified into the following three types:

*UE (no LS)

*LS (through BS)

*LS (through UE)

LS denotes a location server, BS denotes a base station such as a gNB or eNB, and UE denotes a terminal performing transmission and reception through an SL. As described above, the terminal performing transmission and reception through an SL may be a vehicle terminal or a pedestrian terminal. In addition, the terminal performing transmission and reception through an SL may include an RSU having terminal functions, an RSU having base station functions, or an RSU having some of base station functions and some of terminal functions. In addition, the terminal performing transmission and reception through an SL may include a positioning reference unit (PRU), the location of which is known, UE (no LS) denotes an SL terminal not connected to the LS. LS (through BS) denotes an LS connected to a base station. On the contrary, LS (through UE) denotes an LS connected to the SL terminal. Here, LS (through UE) may be available only to certain terminals, such as an RSU or a PRU, other than general terminals. In addition, a terminal connected to the LS through an SL may be defined as a new type of device. In addition, only a particular terminal supporting UE capability connected to the LS may perform a function of connecting to the LS through an SL.

In Table 1 below, Cases 1 to 9 are provided that indicate various combinations of an entity that performs positioning-related configuration and an entity that calculates positioning for measuring a location of a terminal on an SL. A terminal on which location measurement is required to be performed is referred to as a target terminal. In addition, a terminal, the location of which is known and which is able to provide corresponding information for measuring the location of the target terminal, is referred to as an anchor terminal. An anchor terminal may be a terminal, the location thereof is already known (hereinafter, the location of an anchor terminal is referred to as a known location). It is noted that the terms target terminal and anchor terminal may be replaced with other terms. For example, anchor terminal may also be referred to as a PRU. In addition, positioning configuration may be classified into UE-configured and network-configured schemes. In Table 1, in cases in which positioning configuration is UE (no LS), a UE-configured scheme may be applied. The UE-configured scheme is advantageous in that positioning configuration may be performed even when the terminal is not within the network (base station) coverage area. In Table 1, in cases in which positioning configuration is LS (through BS), a UE-configured scheme may be applied. In the network-configured scheme, when a terminal is in the network coverage area, positioning calculation and measurement information is reported to a base station and then measurement of the location of a target UE is performed by an LS connected to the base station. Thus, delay may occur due to signaling related to the location measurement, but more accurate location measurement may be possible. Finally, in Table 1, cases in which positioning configuration is LS (through UE) may not correspond to the network-configured scheme, because the terminal does not operate within the network coverage area through the base station. In addition, although the location is measured by the LS connected to the terminal, the location is not strictly measured by the terminal, these cases may not correspond to the UE-configured scheme. Accordingly_{;} the cases in which positioning configuration is LS (through UE) may correspond to a scheme other than the UE-configured or network-configured schemes.

In addition, positioning calculation may be classified into two schemes, i.e., UE-assisted and UE-based schemes, as described above. In Table 1, cases in which positioning calculation is UE (no LS) may correspond to the UE-based scheme, and cases in which positioning calculation is LS (through BS) or LS (through UE) may generally correspond to the UE-assisted scheme. However, in cases in which positioning calculation is LS (through UE) and the UE is the target UE may also correspond to the UE-based scheme.

TABLE 1

| | Positioning configuration | Positioning calculation |
|---|---|---|
| Case 1 | UE (no LS) | UE (no LS) |
| Case 2 | UE (no LS) | LS (through BS) |
| Case 3 | UE (no LS) | LS (through UE) |
| Case 4 | LS (through BS) | UE (no LS) |
| Case 5 | LS (through BS) | LS (through BS) |
| Case 6 | LS (through BS) | LS (through UE) |
| Case 7 | LS (through UE) | UE (no LS) |
| Case 8 | LS (through UE) | LS (through BS) |
| Case 9 | LS (through UE) | LS (through UE) |

In Table 1, positioning configuration information may include S-PRS configuration information. The S-PRS configuration information may be pattern information of an S-PRS and information related to a time/frequency transmission location. In addition, in Table 1, the positioning calculation may be performed by the terminal receiving an S-PRS and performing measurement from the received S-PRS, and the positioning measurement and calculation method may vary depending on which positioning method is applied. Measurement of location information in an SL may be absolute positioning to provide two-dimensional (x,y) and three-dimensional (x,y,z) coordinate position values of a terminal, or relative positioning to provide relative two-dimensional or three-dimensional position information from another terminal. In addition, the location information in the SL may be ranging information including one of the distance or direction from another terminal. When the location information in the SL includes both distance and direction information, ranging may have the same meaning as that of relative positioning. Also, as a positioning method, SL time difference of arrival (SL-TDOA), SL angle-of-departure (SL-AOD), SL Multi-RTT, SL E-CID, SL angle-of-arrival ISL-AOA), or the like may be considered.

Embodiments are provided of methods of supporting RAT-dependent positioning supported through an SL. That is, the following embodiments relate to a method of transmitting and receiving relevant information for measuring a location of a terminal, a method of configuring and transmitting a signal for measuring the location, a method of measuring the location by using the signal, and terminal operations for performing the methods, and a combination of one or more of the following embodiments may be used.

### First Embodiment

The first embodiment provides a protocol for RAT-dependent positioning supported through an SL. The protocol may be referred to as SL positioning protocol (SPP), though the term SPP may be replaced with other terms. Alternatively, a method in which the function of the SPP provided in the first embodiment is added to the components of the existing LPP may also be considered. In addition, the SPP may not be used when performing positioning in an SL. In other words, the SPP may be applied only in particular cases. The SPP may correspond to a case in which the positioning configuration and the positioning calculation based on an SL described above with reference to Table 1 are performed by an LS. The SPP may correspond to a case in which an LS such as LS (through BS) or LS (through UE) is involved in the positioning configuration and the positioning calculation.

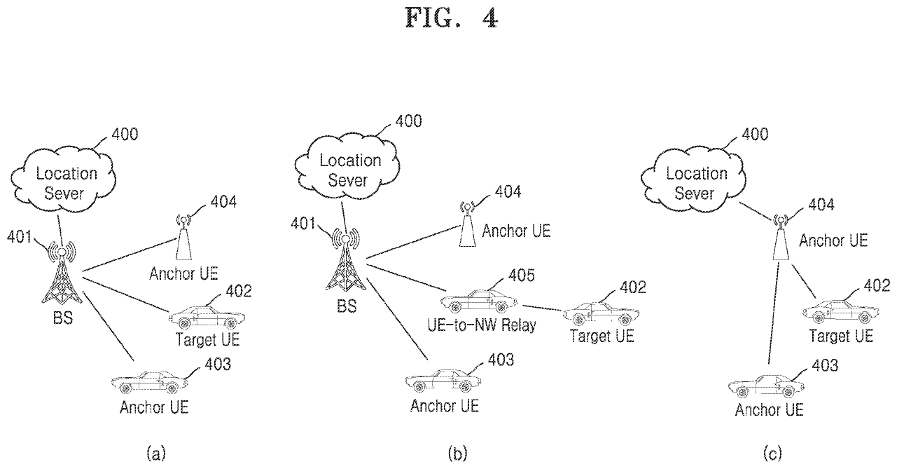

FIG. 4 describes examples of calculating a location of a terminal through an SL by applying an SPP, according to an embodiment.

However, the examples provided in FIG. 4 are not the only cases to which the SPP is applicable.

Part (a) of FIG. 4 illustrates an embodiment of LS (through BS) of Table 1, in which an LS 400 connected to a base station 401 may provide a positioning configuration to SL terminals 402, 403, and 404, with terminal 402 being target terminal and terminals 403 and 404 being anchor terminals. In part (a) of FIG. 4, when the UE-assisted scheme is used, positioning calculation may be performed by the LS 400 using a result of positioning measurement reported by the target terminal 402.

Part (b) of FIG. 4 illustrates another embodiment of LS (through BS) of Table 1. Unlike the example provided in part (a) of FIG. 4, in the example of part (b) of FIG. 4, a UE-to-NW relay 405 through an SL is applied. Thus, even when the target terminal 402 is located outside the coverage area of the base station, the LS and the terminal may exchange positioning-related information with each other through the base station 401. Although part (b) of FIG. 4 illustrates that the target terminal 402 is connected to the relay terminal 405, the anchor terminals 403 and 404 may also perform UE-to-NW relay through the relay terminal 405. Here, the UE-to-NW relay may include a procedure in which the terminal 402 selects the relay terminal 405 within the coverage area of the base station. When the relay terminal 405 is selected, the terminal 402 may receive information (control and data signals) from the base station through the relay terminal 405. When the base station 401 transmits information to the relay terminal 405, the terminal 402 may receive the information transmitted by the base station from the relay terminal 405 through an SL. Therefore, part (b) of FIG. 4 may correspond to a case in which, when the LS 400 connected to the base station 401 provides positioning configuration to the SL terminals 402, 403, and 404, and the UE-assisted scheme is used, positioning calculation may be performed by the LS 400 using a result of positioning measurement reported by the target terminal 402.

Part (c) of FIG. 4 illustrates an embodiment of LS (through UE) of Table 1. Part (c) of FIG. 4 may correspond to a case in which, when the LS 400 connected to the terminal 404 provides positioning configuration to the SL terminals 402 and 403, and the UE-assisted scheme is used, positioning calculation may be performed by the LS 400 using a result of positioning measurement reported by the target terminal 402. Although part (c) of FIG. 4 illustrates that the terminal 404 is an RSU, this is only an example, and the terminal 404 is not limited to the RSU. In other words, a terminal connected to the LS through an SL may be defined as a new type of device. In addition, only a terminal specified by UE capability may perform a function of connecting to an LS through an SL. For example, when groupcast is performed on an SL, a leader terminal may be a terminal connected to an LS.

Roles and information required when an LS is used in an SL to perform positioning as described above are described herein. The roles of respective components in the above descriptions of the LPP may be equally applied to and included in the SPP below. Hereinafter, the description will focus on the features related to positioning in an SL.

Positioning Capability Exchange:

*Information about a frequency band used by the terminal in the SL, exchanged as positioning capability information. In this case, the information about the frequency domain may be SL BWP information. When the information is transmitted to the LS, the LS may perform positioning based on the information. In addition, the LS may adjust (change and extend), based on the information, the frequency band in which the terminal operates in the SL, and information about the adjusted frequency band is transmitted to the terminal.

*Information about a resource pool used by the terminal in the SL, exchanged as positioning capability information. In this case, the information about the resource pool may be interpreted as information about time and frequency resource bands used for SL transmission and reception. Also, the information about the resource pool may be a dedicated resource pool used for positioning. When the information is the dedicated resource pool used for positioning, only positioning-related signals may be transmitted and received in the pool. When the information is transmitted to the LS, the LS may perform positioning based on the information. In addition, the LS may adjust (change and extend), based on the information, a resource pool domain in which the terminal operates in the SL, and transmit information about the adjusted resource pool domain to the terminal.

*S-PRS configuration information usable by the terminal and a supportable positioning method, exchanged as positioning capability information. When the information is transmitted to the LS, the LS may perform positioning based on the information. In addition, based on the information, the LS may adjust S-PRS configuration transmitted by the terminal in the SL or modify the positioning method, and transmit the result to the terminal.

*Information about whether the terminal is able to perform UE-to-NW relay in the SL, exchanged as positioning capability information. The information may be transmitted to the LS, and the LS may perform positioning based on the information. That is, information exchange for positioning may be performed between the LS and the terminal through a relay terminal.

Assistance Data Transmission:

*Configuration information provided by the LS to the terminal for an S-PRS and information about candidate anchor terminals to receive the S-PRS. In this case, the information about the candidate anchor terminals to receive the S-PRS may include UE identification (ID) information.

In order for the LS to provide the terminal with the information about the candidate anchor terminals to receive the S-PRS, an SL terminal needs to provide the UE ID information to the LS. This may be classified as assistance data transmission. However, an operation, performed a terminal, of providing UE ID information to an LS through an SPP may be classified as other component. A UE ID provided by an SL terminal to an LS may be a source ID used for an SL, a destination ID used for an SL, an SL synchronization ID, an S-PRS ID, or a cell ID to which the terminal belongs. In addition, the UE ID provided by the SL terminal to the LS may be configured with a combination of one or more of the aforementioned IDs and then used.

Location information transmission:

*The LS may request location information from the SL terminal, and the terminal may provide measured location information to the LS in response to the request. Here, the location information may vary depending on whether the positioning is UE-assisted or UE-based, and, in this case, the level of the location information may vary depending on whether the requested location information is absolute positioning, relative positioning, or ranging, in the SL. In addition, the measurement method and the measured value may vary depending on which positioning method is used in the SL. When the LS requests the location information from the terminal, the LS may include required accuracy, response time, and the like, in positioning QoS information. Upon the request including the positioning QoS information, the terminal needs to provide the LS with the measured location information to satisfy the corresponding accuracy and response time.

Error Handling:

*When location information measured in the SL is not valid, error handling may be performed. For example, when a measured location information value does not satisfy the response time, error handling may be performed.

Abort:

**When positioning-related performance is no longer possible in the SL, positioning-related procedures may be aborted. For example, when a radio link failure (RLF) is declared in the SL. transmission and reception through the SL may be unavailable for a while. Thus, an SL positioning operation may be aborted.

The components and roles of the SPP may not be limited only to the above description. In other words, additional components and roles may be considered for SL positioning using an LS,

### Second Embodiment

The second embodiment provides a method of configuring and transmitting a signal for a terminal to measure a location through an SL.

Whether the terminal is able to perform positioning through the SL, i.e., whether the terminal is capable of performing a positioning operation, may be determined by UE capability, and corresponding capability information may be transmitted to other terminals and a base station. In this case, whether the terminal is capable of performing positioning through the SL may also be determined by whether an SL positioning signal is transmitted/received. In this case, the SL positioning signal may be an S-PRS to be transmitted and received for positioning measurement. For example, a certain SL terminal may be a terminal capable of both transmitting and receiving an S-PRS. In addition, a certain SL terminal may be a terminal capable of transmitting an S-PRS but incapable of receiving an S-PRS. In addition, a certain SL terminal may be a terminal capable of receiving an S-PRS but incapable of transmitting an S-PRS. In addition, a certain SL terminal may be a terminal incapable of neither transmitting nor receiving an S-PRS, Whether a terminal is capable of transmitting/receiving an S-PRS may be defined in UE capability.

Next, when the terminal performs positioning through the SL, positioning-related configuration information may be (pre-)configured. For example, S-PRS information may be (pre-)configured as positioning-related information. As another example, information about a positioning method may be (pre-)configured as positioning-related information. As discussed with reference to Table 1, when the terminal does not receive positioning configuration from another terminal or an LS, the terminal may comply with positioning configuration information that is pre-configured and then stored therein. For example, in this case, the terminal may be out of the network coverage area. As another example, no positioning-related configuration information is received from any other terminals. After a certain time point, the terminal may be configured with positioning configuration information from another terminal or an LS. In a case corresponding UE (no LS) or LS (through UE) of Table 1 in which the terminal is configured with positioning information from another terminal, the positioning configuration information may have been transmitted via broadcast, unicast, or groupcast through an SL, and may be indicated by SCI (first-stage SCI or second-stage SCI) or, when transmitted via unicast transmission, by PC5-RRC or an SL MAC-CE. In a case corresponding to LS (through UE) in which the terminal is connected to the LS, the terminal may configure itself with positioning information from the LS. On the other hand, in a case corresponding to LS (through BS) of Table 1 in which the terminal is configured with positioning configuration information from the LS connected to the base station, the terminal may be configured with positioning configuration information from the base station in a cell-common manner. As noted above, cell-common may mean that terminals in a cell receive the same information configuration from a base station. In this case, the terminals may consider a method of receiving an SL-SIB from the base station and obtaining cell-common information. It may also mean a case in which the terminal is configured in a UE-specific manner after an RRC connection with the base station is established.

As described above, when the terminal does not receive positioning configuration from another terminal or an LS, the terminal may transmit or receive a positioning signal according to positioning configuration information that is pre-configured and is then stored therein. When the terminal is configured with positioning information from another terminal or an LS after a certain time point, one or more pieces of information may be configured with. For example, the S-PRS information may be determined such that only one pattern is configured, and it may be allowed to configure one or more pieces of pattern information. When one or more pieces of pattern information is configured, the terminal may transmit the corresponding configuration information to the LS through the SPP described in the first embodiment, and the LS may determine an appropriate S-PRS pattern and indicate the determined S-PRS pattern to the terminal. One or more S-PRS patterns may be configured through PC5-RRC or may be pre-configured in the terminal, and one of them may be specified through SCI. As another example, it may be determined that the information about the positioning method is configured in only one method, and it may be allowed to configure information about one or more positioning methods. Here, the information about the positioning method may include information about whether the method is UE-based or UE-assisted. Alternatively, the information about the positioning method may include information about whether the method is absolute positioning, relative positioning, or ranging. Alternatively, the information about the positioning method may include information about whether the method is SL-TDOA, SL-AOD, SL Multi-RTT, SL E-CID, or SL-AOA. When one or more pieces of pattern information is configured, the terminal may transmit the corresponding configuration information to the LS through the SPP described in the first embodiment, and the LS may determine an appropriate positioning method based on the configuration information and indicate the determined positioning method to the terminal

When the terminal performs positioning through an SL, the terminal may transmit a positioning signal through the SL. Here, the positioning signal may be referred to as S-PRS. Methods of transmitting an S-PRS in an SL may be classified into two categories:

*Transmission of S-PRS from anchor terminal to target terminal

*Transmission of S-PRS from target terminal to anchor terminal

Depending on the positioning method used, one or both of the above categories may be performed. For example, when SL-TDOA is performed, SL positioning may be performed by transmitting an S-PRS by using the first method. On the other hand, when SL Multi-RTT is performed, both of the S-PRS transmission methods may be required. When both of the S-PRS transmission methods are performed, an S-PRS used in the first method and an S-PRS used in the second method may be of the same type of positioning signal or different types of positioning signals.

### Third Embodiment

The third embodiment provides a positioning procedure for a case in which an LS is not involved in positioning-related configuration when measuring a location of a terminal through an SL. The third embodiment provides a method of transmitting and receiving relevant information and signals to measure the location, and an operation of measuring the location through by using the method.

Because cases in which the terminal is out of the network coverage area are always considered in an SL environment, a case in which the LS is unable to perform positioning-related configuration should be considered when it is assumed that the LS is connected to the base station. The embodiment provides an operation, performed by a target terminal on which location measurement is required to be performed, performing positioning-related configuration in such a case. The target terminal may perform broadcast, unicast, or groupcast transmission of indications of various pieces of positioning-related configuration information provided in the second embodiment, to another terminal through an SL. The corresponding information may be indicated by SCI (first-stage SCI or second-stage SCI) or PC5-RRC or an SL MAC-CE when performing the unicast transmission. In this scenario, the corresponding information may also include a request signal for an S-PRS. In other words, the target terminal may indicate, to a neighboring terminal through the SL, the request signal for the S-PRS, together with relevant positioning configuration information. In addition, when UE-based positioning is considered, a scheme in which the target terminal directly measures the absolute position of the terminal may be considered. In order for the target terminal to directly measure the absolute position of the terminal, it is necessary for an anchor terminal to indicate its known location to the target terminal through an SL. The anchor terminal may perform broadcast, unicast, or groupcast transmission of information about the known location through an SL to indicate the known location to the target terminal. Information about the known location may be indicated by SCI (first-stage SCI or second-stage SCI) or, when performing the unicast transmission, by PC5-RRC or an SL MAC-CE.

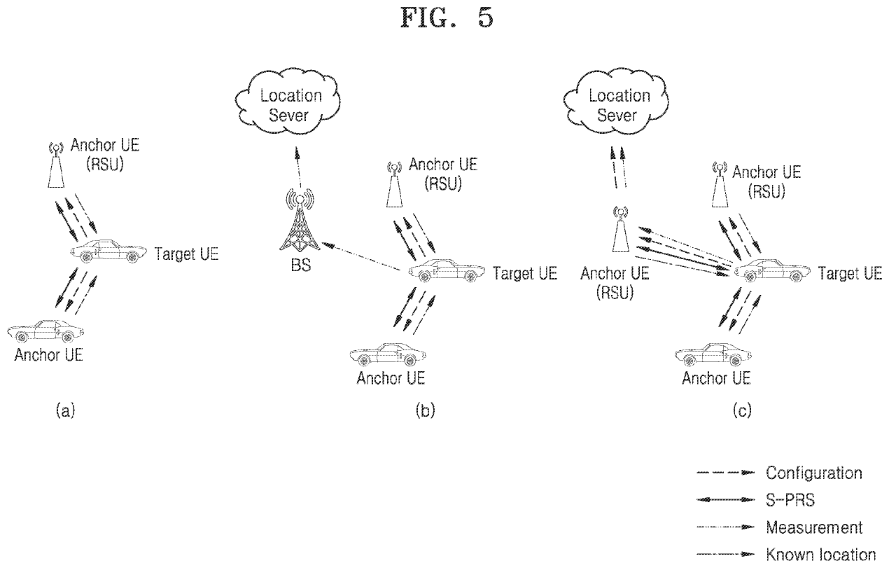

FIG. 5 describes examples of calculating a location of a terminal through an SL, according to the third embodiment. However, cases in which a location of a terminal is calculated through an SL according to the third embodiment are not limited to the examples illustrated in FIG. 5.

Part (a) of FIG. 5 illustrates an example in which an SL terminal not connected to an LS provides positioning configuration and a target terminal not connected to the LS performs positioning calculation. This may correspond to Case 1 of Table 1. In this case, the method provided in the third embodiment may be used as a method, performed by an SL terminal, of providing and indicating positioning configuration information. In addition, the target terminal may perform positioning calculation based on the provided configuration information.

Part (b) of FIG. 5 illustrates an example in which an SL terminal not connected to an LS provides positioning configuration, a target terminal is located within network coverage area, and thus the LS connected to a base station performs positioning calculation. This may correspond to Case 2 of Table 1. In this case, the method provided in the third embodiment may be used as a method, performed by an SL terminal, of providing and indicating positioning configuration information. In addition, the target terminal performs positioning measurement based on the provided configuration information, and reports measured positioning information to the base station because the target terminal is within the coverage area of the base station. Then, corresponding measurement information may be reported to the LS connected to the base station, and thus the LS may perform positioning calculation.

Part (c) of FIG. 5 illustrates an example in which an SL terminal not connected to an LS provides positioning configuration and the LS performs positioning calculation through an SL terminal connected to the LS. This may correspond to Case 3 of Table 1. In this case, the method provided in the third embodiment may be used as a method, performed by an SL terminal, of providing and indicating positioning configuration information. In addition, the target terminal performs positioning measurement based on the provided configuration information, and reports measured positioning information to a terminal connected to the LS because the target terminal is within SL coverage with the terminal connected to the LS. Part (c) of FIG. 5 illustrates that the terminal connected to the LS is an anchor UE, i.e., an RSU, but it is noted that the terminal may be a terminal other than the RSU. Then, corresponding measurement information may be reported to the LS connected to the anchor UE, i.e., an RSU, and thus the LS may perform positioning calculation.

### Fourth Embodiment

The fourth embodiment provides a positioning procedure for a case in which an LS connected to a base station provides positioning-related configuration when measuring a location of a terminal through an SL. The fourth embodiment provides a method of, in such a case, transmitting and receiving relevant information and signals to measure the location, and an operation of measuring the location through by using the method.

When the LS connected to the base station provides the positioning-related configuration, the operation may be performed through positioning information configuration and a positioning procedure through the existing LPP. Refer to the LPP and SPP described above for a positioning support method for such a case.

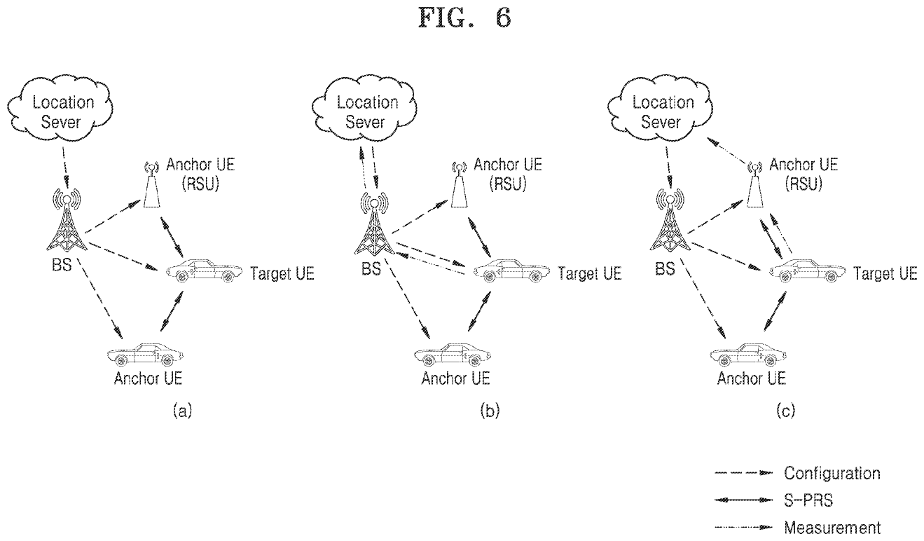

FIG. 6 describes examples of calculating a location of a terminal through an SL, according to the fourth embodiment. However, cases in which a location of a terminal is calculated through an SL according to the fourth embodiment are not limited to the examples illustrated in FIG. 6.

Part (a) of FIG. 6 illustrates an example in which an SL terminal is located within network coverage, an LS connected to a base station provides positioning configuration, and a target terminal not connected to the LS performs positioning calculation. This may correspond to Case 4 of Table 1. In this case, the method (using an LPP and SPP) provided in the fourth embodiment may be used as a method, performed by the LS connected to the base station, of providing and indicating positioning configuration information. In addition, the target terminal may perform positioning calculation based on the provided configuration information.

Part (b) of FIG. 6 illustrates an example in which an SL terminal is located within network coverage, an LS connected to a base station provides positioning configuration, a target terminal is located within the network coverage, and the LS connected to the base station performs positioning calculation. This may correspond to Case 5 of Table 1. In this case, the method (using an LPP and SPP) provided in the fourth embodiment may be used as a method, performed by the LS connected to the base station, of providing and indicating positioning configuration information. In addition, the target terminal performs positioning measurement based on the provided configuration information, and reports measured positioning information to the base station because the target terminal is within the coverage area of the base station. Then, corresponding measurement information may be reported to the LS connected to the base station, and thus the LS may perform positioning calculation.

Part (c) of FIG. 6 illustrates an example in which an SL terminal is located within network coverage, an LS connected to a base station provides positioning configuration, and the LS performs positioning calculation through an SL terminal connected to the LS. This may correspond to Case 6 of Table 1. In this case, the method (using an LPP and SPP) provided in the fourth embodiment may be used as a method, performed by the LS connected to the base station, of providing and indicating positioning configuration information. In addition, the target terminal performs positioning measurement based on the provided configuration information, and reports measured positioning information to a terminal connected to the LS because the target terminal is within SL coverage with the terminal connected to the LS. Part (c) of FIG. 6 illustrates that the terminal connected to the LS is an anchor UE, i.e., an RSU, but it is noted that the terminal may be a terminal other than the RSU. Then, corresponding measurement information may be reported to the LS connected to the anchor UE, i.e., an RSU, and thus the LS may perform positioning calculation.

### Fifth Embodiment

The fifth embodiment provides a positioning procedure for a case in which an LS connected to an SL terminal provides positioning-related configuration when measuring a location of a terminal through an SL. The fifth embodiment provides a method of, in such a case, transmitting and receiving relevant information and signals to measure the location, and an operation of measuring the location through by using the method.

When the LS connected to the terminal provides the positioning-related configuration, the operation may be performed through positioning information configuration and a positioning procedure through the SPP, as described above.

The embodiment provides an operation, performed by the terminal connected to the LS, of indicating positioning-related configuration information through an SL in such a case, The terminal connected to the LS may perform broadcast, unicast, or groupcast transmission of indications of various pieces of positioning-related configuration information provided in the second embodiment, to another terminal through an SL. The corresponding information may be indicated by SCI (first-stage SCI or second-stage SCI) or PC5-RRC or an SL MAC-CE when performing the unicast transmission. In this case, the corresponding information may also include a request signal for an S-PRS. In addition, when UE-based positioning is considered, a scheme in which the target terminal directly measures the absolute position of the terminal may be considered. In order for the target terminal to directly measure the absolute position of the terminal, it is necessary for an anchor terminal to indicate its known location to the target terminal through an SL. As a method, performed by an anchor terminal, of indicating a known location to a target terminal, broadcast, unicast, or groupcast through an SL may be considered. The corresponding information may be indicated by SCI (first-stage SCI or second-stage SCI) or PC5-RRC or an SL MAC-CE when performing the unicast transmission.

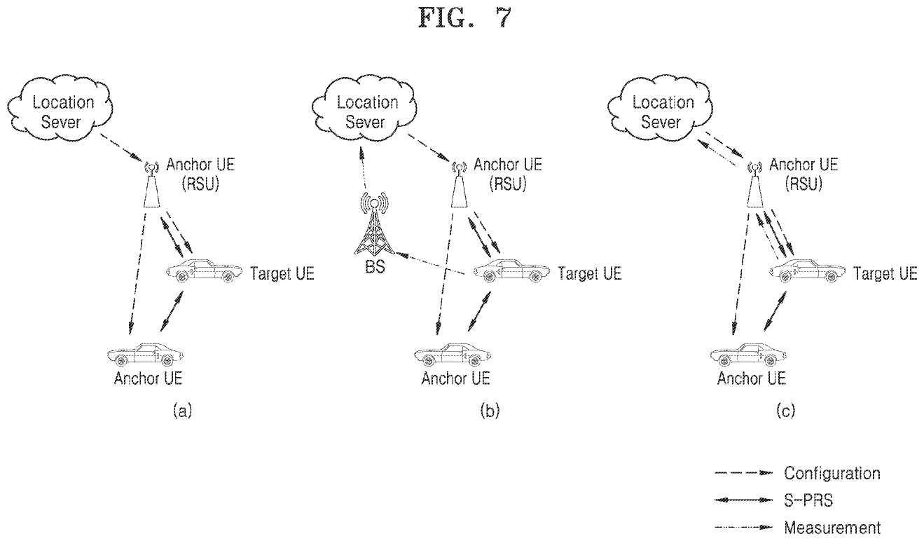

FIG. 7 describes examples of calculating a location of a terminal through an SL, according to the fifth embodiment. However, in the disclosure, cases in which a location of a terminal is calculated through an SL according to the fifth embodiment are not limited to the examples illustrated in FIG. 7.

Part (a) of FIG. 7 illustrates an example in which an LS provides positioning configuration through an SL terminal connected to the LS, and a target terminal not connected to the LS performs positioning calculation. This may correspond to Case 7 of Table 1. In this case, the method (using an SPP) provided in the fifth embodiment may be used as a method, performed by the LS connected to the terminal, of providing and indicating positioning configuration information. In addition, the target terminal may perform positioning calculation based on the provided configuration information.

Part (b) of FIG. 7 illustrates an example in which an LS provides positioning configuration through an SL terminal connected to the LS, a target terminal is located within network coverage, and the LS connected to a base station performs positioning calculation. This may correspond to Case 8 of Table 1. In this case, the method (using an SPP) provided in the fifth embodiment may be used as a method, performed by the LS connected to the terminal, of providing and indicating positioning configuration information. In addition, the target terminal performs positioning measurement based on the provided configuration information, and reports measured positioning information to the base station because the target terminal is within the coverage of the base station. Then, corresponding measurement information may be reported to the LS connected to the base station, and thus the LS may perform positioning calculation.

Part (c) of FIG. 7 illustrates an example in which an LS provides positioning configuration through an SL terminal connected to the LS, and the LS performs positioning calculation through the SL terminal connected to the LS. This may correspond to Case 9 of Table 1. In this case, the method (using an SPP) provided in the fifth embodiment may be used as a method, performed by the LS connected to the terminal, of providing and indicating positioning configuration information. In addition, the target terminal performs positioning measurement based on the provided configuration information, and reports measured positioning information to a terminal connected to the LS because the target terminal is within SL coverage with the terminal connected to the LS. Part (c) of FIG. 7 illustrates that the terminal connected to the LS is an anchor UE, i.e., an RSU, but it is noted that the terminal may be a terminal other than the RSU. Then, corresponding measurement information may be reported to the LS connected to the anchor UE, i.e., an RSU, and thus the LS may perform positioning calculation.

The detailed examples for describing the above-described first to fifth embodiments are combinations of at least one of the methods or operations for providing SL positioning, In addition, SL positioning may be performed by combining the respective methods or operations disclosed in different embodiments. For example, by combining the operation of receiving positioning configuration information from an SL terminal in the third embodiment with the operation of receiving positioning configuration information from an LS in the fourth embodiment, part of positioning configuration information may be received from a sidelink terminal, and the remaining positioning configuration information may be received from an LS. However, this is only an example, and the respective methods or operations of two or more other embodiments may be combined for SL positioning.

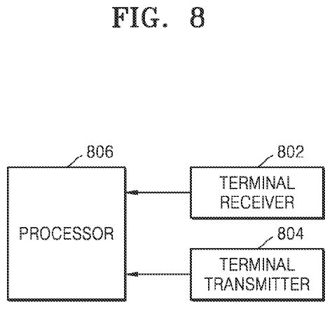

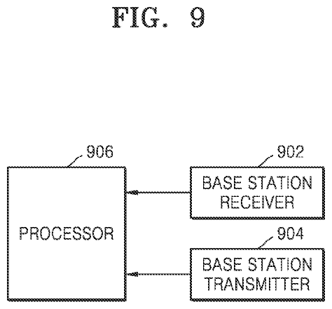

Transmitters, receivers, and processors of a terminal and a base station for performing the above embodiments are illustrated in FIGS. 8 and 9, respectively. The method, performed by a terminal, of performing positioning in an SL is described in the above embodiments, and in order to perform the method, receivers, processors, and transmitters of a base station and a terminal need to operate according to the embodiments.

FIG. 8 illustrates an internal structure of a terminal according to an embodiment. As illustrated in FIG. 8, the terminal may include a terminal receiver 802, a terminal transmitter 804, and a processor 806. The terminal receiver 802 and the terminal transmitter 804 may be collectively referred to as a transceiver. The transceiver may transmit and receive signals to and from another device. For example, the transceiver may transmit and receive signals to and from at least one of another terminal, a base station, or an LS. The signal may include control information and data. To this end, the transceiver may include an RF transmitter for up-converting and amplifying a frequency of a signal being transmitted, and an RF receiver for low-noise-amplifying a received signal and down-converting a frequency of the received signal, Also, the transceiver may receive a signal through a radio channel, output the signal to the processor 806, and transmit a signal output from the processor 806 through a radio channel. The processor 806 may control a series of operations to allow the terminal to operate according to the above-described embodiments.

FIG. 9 illustrates an internal structure of a base station according to an embodiment. As illustrated in FIG. 9, the base station may include a base station receiver 902, a base station transmitter 904, and a processor 906. The base station receiver 902 and the base station transmitter 904 may be collectively referred to as a transceiver. The transceiver may transmit and receive signals to and from a terminal. Also, the transceiver may transmit and receive signals to and from an LS. The signal may include control information and data. To this end, the transceiver may include an RF transmitter for up-converting and amplifying a frequency of a signal being transmitted, and an RF receiver for low-noise-amplifying a received signal and down-converting a frequency of the received signal. Also, the transceiver may receive a signal through a radio channel, output the signal to the processor 906, and transmit a signal output from the processor 906 through a radio channel. The processor 906 may control a series of operations to allow the terminal to operate according to the above-described embodiments.

The disclosure provides a method and procedure for a terminal to perform positioning through an SL, to enable position measurement in an SL.

While the disclosure has been particularly shown and described with reference to certain embodiments thereof, it will be understood by those of ordinary skill in the art that various changes in form and details may be made therein without departing from the spirit and scope of the disclosure as defined by the appended claims and equivalents thereof.

What is claimed is:

1. A method, performed by a terminal, the method comprising:
transmitting positioning capability information of the terminal to at least one of a base station or another terminal;
receiving positioning configuration information from at least one of the base station, the other terminal or a location server connected with at least one of the base station or the other terminal;
receiving a sidelink-positioning reference signal (S-PRS) based on the positioning configuration information; and
transmitting positioning information based on the S-PRS.

2. The method of claim 1, wherein the positioning capability information includes information regarding at least one of a sidelink bandwidth part (BWP), a resource pool for a sidelink positioning, an S-PRS configuration of the terminal, a positioning scheme of the terminal, or a relay support.

3. The method of claim 1, wherein the positioning configuration information includes information regarding an S-PRS configuration and a positioning scheme provided for the terminal.

4. The method of claim 1,
wherein, in case that the positioning configuration information is transmitted from the location server to the other terminal, receiving the positioning configuration information from the other terminal connected with the location server, and wherein, in case that the positioning configuration information is transmitted from the location server to the base station, receiving the positioning configuration information from the base station connected with the location server.

5. The method of claim 1, further comprising, in case that the terminal is out of a coverage area, receiving positioning configuration information of the other terminal or identifying pre-configured positioning configuration information,
wherein receiving the S-PRS is performed based on the positioning configuration information.

6. The method of claim 1, wherein the positioning configuration information is received via one or more control signals including a PC5 radio resource control (RRC) signaling, sidelink medium access control-control element (MAC-CE) and sidelink control information (SCI).

7. The method of claim 1, further comprising identifying a measurement value based on the received S-PRS or a position of the terminal based on the received S-PRS and known location information,
wherein transmitting of the positioning information includes transmitting the measurement value or the position of the terminal.

8. The method of claim 1, further comprising receiving a request for the positioning information from the location server,
wherein the request for the positioning information includes information regarding accuracy and a response time for a positioning operation.

9. The method of claim 1, wherein transmitting the positioning information comprises transmitting the positioning information to the base station,
wherein the positioning information is transferred from the base station to the location server, and
wherein a position of he terminal is identified at the location server based on the positioning information.

10. The method of claim 1, wherein transmitting the positioning information comprises transmitting the positioning information to the other terminal,
wherein the positioning information is transferred from the other terminal to the location server, and
wherein a position of the terminal is identified at the location server based on the positioning information.

11. A terminal comprising:
a transceiver; and
at least one processor coupled with the transceiver and configured to:
transmit positioning capability information of the terminal to at least one of a base station or another terminal,
receive positioning configuration information from at least one of the base station, the other terminal or a location server connected with at least one of the base station or the other terminal,
receive a sidelink-positioning reference signal (S-PRS) based on the positioning configuration information, and
transmit positioning information based on the S-PRS.

12. The terminal of claim 11, wherein the positioning capability information includes information regarding at least one of a sidelink bandwidth part (BWP), a resource pool dedicated for a sidelink positioning, an S-PRS configuration of the terminal, a positioning scheme of the terminal, or a relay support.

13. The terminal of claim 11, wherein the positioning configuration information includes information regarding an S-PRS configuration and a positioning scheme provided for the terminal.

14. The terminal of claim 11, wherein the at least one processor is further configured to:
in case that the positioning configuration information is transmitted from the location server to the other terminal, receive the positioning configuration information from the other terminal connected with the location server, and
in case that the positioning configuration information is transmitted from the location server to the base station, receive the positioning configuration information from the base station connected with the location server.

15. The terminal of claim 11, wherein the at least one processor is further configured to, in case that the terminal is out of a coverage area, receive positioning configuration information of the other terminal or identify pre-configured positioning configuration information, and
wherein the receiving of the S-PRS is performed based on the positioning configuration information.

16. The terminal of claim 11, wherein the at least one processor is further configured to receive the positioning configuration information via one or more control signals including a PC5 radio resource control (RRC) signaling, sidelink medium access control-control element (MAC-CE) and sidelink control information (SCI).

17. The terminal of claim 11, wherein the at least one processor is further configured to:
identify a measurement value based on the received S-PRS or a position of the terminal based on the received S-PRS and known location information, and
transmit the positioning information including the measurement value or the position of the terminal.

18. The terminal of claim 11, wherein the at least one processor is further configured to receive a request for the positioning information from the location server,
wherein the request for the positioning information includes information regarding accuracy and a response time for a positioning operation.

19. The terminal of claim 11, wherein the at least one processor is further configured to transmit the positioning information to the base station,
wherein the positioning information is transferred from the base station to the location server, and
wherein a position of the terminal is identified at the location server based on the positioning information.

20. The terminal of claim 11, wherein the at least one processor is further configured to transmit the positioning information to the other terminal,
wherein the positioning information is transferred from the other terminal to the location server, and
wherein a position of the terminal is identified at the location server based on the positioning information.
